(19) United States
(12) Patent Application Publication
(10) Pub. No.: US 2008/0199593 A1
(43) Pub. Date: Aug. 21, 2008

(54) Fish food flakes

(75) Inventor: Lauren Keilbach, New York, NY (US)

Correspondence Address: GOTTLIEB RACKMAN & REISMAN PC, 270 MADISON AVENUE, 8TH FLOOR, NEW YORK, NY, 10016-0601, US

(73) Assignee: THE HARTZ MOUNTAIN CORPORATION

(21) Appl. No.: 12/148,851

(22) Filed: Apr. 23, 2008

Related U.S. Application Data
(62) Division of application No. 10/803,803, filed on Mar. 18, 2004.
(60) Provisional application No. 60/533,579, filed on Dec. 30, 2003.
(60) Provisional application No. 60/535,394, filed on Jan. 9, 2004.

(51) Int. Cl. A23L 1/326

(52) U.S. Cl. 426/643

(57) ABSTRACT

A method of preparing fish food flakes is provided. The method includes the steps of preparing a slurry that incorporates fish meal and flour, applying heat to the slurry in order to dry the slurry into a sheet, adding a solution containing one or more water dispersable nutritional ingredients to the slurry as the slurry is drying such that the slurry has sufficiently cooled in order to prevent degradation of the applied nutritional ingredients, and breaking up the dried slurry after the solution containing the nutritional ingredients has been added in order to form a plurality of fish flakes.

This application claims priority of provisional application No. 60/533,579, filed Dec. 30, 2003 as well as provisional application No. 60/535,394, filed Jan. 9, 2004.

### BACKGROUND

This application is directed to an improved fish food flake product, and more particularly to a method of producing a fish food flake product having improved nutritional characteristics.

Many homes as well as businesses have aquariums of fish and other aquatic life. Not only do fish aquariums enable one to maintain various forms of aquatic life as a pet, they can provide an aesthetic value as well as enhancing the look or appeal of a room.

In order to maintain the fish in a fish aquarium, it is obviously necessary to regularly feed the fish with some type of food product. The most common type of fish food product, and the one most readily available in most fish and pet food stores, are fish flakes, which typically consist of fish meal in combination with flour or other starch type product. One of the more common ways to prepare fish food flakes is to first prepare a slurry that has fish meal and flour added thereto. The slurry is then applied to a heated drum in order to cook and gelatinize the starches in the slurry in order to bind the starch components, as well as for the purpose of drying the slurry into a sheet type product. The sheet product is then broken up by appropriate tool mechanisms in order to form fish flakes.

As with other animals, it is desirable to add vitamins and other nutritional ingredients to the fish food source in order to enhance the animal's health and fortitude. Traditionally, vitamins and other nutritional ingredients were incorporated into fish flakes by adding them directly into the flake slurry during preparation. The disadvantage of doing so was that it exposed the vitamins and other nutritional ingredients to high temperature and moisture conditions. As a result, significant degradation of these ingredients occurred, thereby preventing delivery of an appropriate amount of these nutritional ingredients.

Accordingly, it would be desirable to provide an improved method and system for significantly reducing the degradation of vitamins and other nutritional ingredients that are added during the production of fish food flakes.

### SUMMARY OF THE INVENTION

The invention is directed to a method of spraying a solution containing any of the following ingredients: vitamins, minerals, carotenoids, palatants, attractants natural colors or any water dispersable ingredient onto fish flakes.

The invention involves the spraying of Vitamin C and natural colors or carotenoids, attractants, palatants onto the flakes near the end of the heating process by means of a novel spray solution and methodology. This will prevent the degradation of these ingredients by limiting the heat that comes into contact with said ingredients.

Vitamin C necessary for development of normal growth, skin, gill, fin development and also has been shown to stimulate the immune system to fight against disease. By spraying Vitamin C onto the fish flake near the end of the manufacturing process, more Vitamin C will be retained in the product compared to the standard method of flaking.

The inventive sprayed flake was analyzed for Vitamin C content and was at the high end of the requirement for Vitamin C. If analyzed, the sprayed flake will most likely be above the requirement for Vitamin C at the end of the product's shelf life (approximately 2 years), whereas with the typical flaking process, this will not be the case.

Therefore, one can guarantee that the fish that eats the sprayed flake anytime from time of manufacture up until two years from the date of manufacture, it will be getting the required amount of Vitamin C to sustain its health.

The two natural colors that were selected (carmine and fruit & vegetable extracts are providing color to the spray solution for visual differentiation (a speckled look). Marigold extract has been added to the spray solution, which is supplying the carotenoids to the fish. Carotenoids will provide health benefits, and will promote color development in the skin of the fish.

This invention is the application by means of a liquid spray solution of a multitude of ingredients onto the external surface of the flake at the end of the processing step of the flake. The ingredients that are being sprayed onto the flake are heat labile and degrade readily at high temperatures. By spraying these ingredients at the end of processing, thereby limiting the heat exposure, these ingredients will presumably retain more of their potency and will have a longer shelf life in the product.

The inventive process involves the spraying of ingredients that are subject to degradation by heat onto the flake right before it comes off the drum. The spray nozzles are positioned under the drum and will spray a solution containing vitamin C and natural colors and/or any other ingredients onto the flake seconds before it comes off the drum and is collected.

An important part of the invention is the spray nozzles or guns and the equipment associated with the nozzles. Without the nozzles, the solution would not be able to be physically applied to the flake. The vitamin spray solution is also an important part of the invention. The purpose of the invention is to prevent degradation of vitamins etc. so that they remain more stable and are in abundance so that the fish can ingest the vitamins and utilize them efficiently.

Traditionally, vitamins and carotenoids are added directly into the flake slurry, which is then exposed to high temperatures and high moisture, causing degradation of essential nutrients and carotenoids required by the fish to maintain health and promote coloration of the skin. This invention will prevent such degradation, thereby delivering 90-100% of the required vitamins, carotenoids and other essential nutrients.

It is important to the invention that the particle size of the materials suspended in the liquid spray solution are not too large and do not clog the nozzles in order to achieve the desired pattern and to avoid applying too much liquid onto the flakes. The particles size must be 150 microns or smaller. The air pressure and atomizing pressure must also be at a certain range to achieve the desired spray pattern of speckled dots with enough distance between them and few of them so that one can see the base flake material.

It is also important that the base liquid for the spray solution suspension be water or water based. Oil or hydrophobic substances should not be used as the liquid base. The particles to be dissolved should be water soluble or water dispsersable and be capable of being suspended in the aqueous solution.

In summary, this invention is useful because it prevents the degradation of essential nutrients and required substances in order to enhance the life of the fish.

It is therefore an object of the invention to provide an improved nutritionally enhanced fish food flake product.

Another object of the invention is to provide an improved method of preparing fish food flakes, which reduces the degradation of added nutritional ingredients.

A further object of the invention is to provide the addition of nutritional ingredients to fish food flakes products by means of a spray technique.

Still other objects and advantages of the invention will, in part, be obvious and will, in part, be apparent from the following description.

### BRIEF DESCRIPTION OF THE DRAWINGS

For a fuller understanding of the invention, reference is made to the following description, taken in connection with the accompanying drawings, in which:

FIG. 1 is a front elevational view of the rotating drums and spray guns used carrying out the inventive method; and

FIG. 2 is a top plan view of a fish flake product produced by the inventive method.

### DETAILED DESCRIPTION

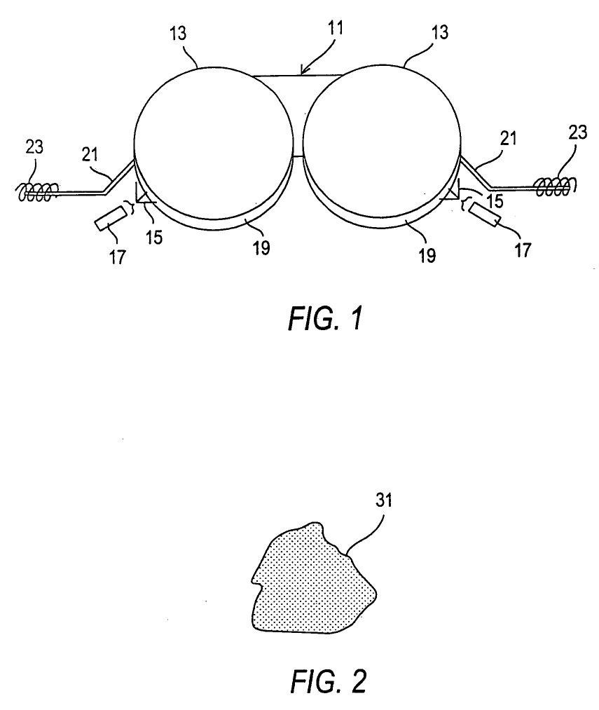

Referring in part to FIG. 1, the inventive method begins with a slurry 11 consisting mainly of at least fish meal and wheat flour, plus a small amount of fish oil, that is pumped along a heated drum. The slurry is about 70%-80% water. The slurry is about 20%-30% solids.

As slurry 11 (which is defined as having between 70-80% moisture) is pumped along drum 13, the temperature of the steam injected into the drum is at least 300° F., preferably, 300°-350° F., which is cooking/gelatinizing the starches in the slurry (for binding) as well as drying the slurry down to a moisture of between 2-10% in order to form a dried flake sheet. At the same time, a liquid nutritional spray solution 15 is sprayed onto the dried flake sheet 19 by means of spray guns 17 (See FIG. 1) 1-4 seconds before the dried sheet comes off drum 13. The dried flake sheet 21, now sprayed by the liquid nutritional solution 15, is then broken up by a rotating screw into smaller pieces (flakes). The flakes travel along a conveyer and then are passed over a screen (a piece of equipment called a classifier) to further reduce the size of the flakes and screen out any undesirable material such as fines or clumps of flake. The resulting fish flakes 31 (see FIG. 2) are then suitable for sale and use.

This liquid spray solution includes, in addition to water, some type of natural colorant and vitamin C. The Vitamin C should be pulverized to 150 microns or smaller in order not to clog the screen on the spraying equipment; it is preferred that it is esterified since the esterified vitamin C adds extra protection from the heat used during processing, although the free form of ascorbic acid can be used. Attractants (stimulates sensors of the fish) and carotenoids may also be added.

Chart A below identifies the various ingredients that may be included in the spray solution of the inventive system, the weight percent amount of each if included in the spray solution, and the preferred weight percent ranges of each.

CHART A
Spray Solution

| | Weight % of Preferred | Weight % |
|---|---|---|
| Ingredients | Formulation | Range |
| Water | 73.8 | 70-75 |
| Liquid Colorant | 20 | 15-25 |
| Rovimix-Vitamin C | 5 | 1-6 |
| (pulverized) | | |
| Marigold Extract- | 1 | 0.0-2 |
| Carotenoid | | |
| Betaine-Attractant | 0.2 | 0-0.3 |
| | 100 | |

The colorant of the spray solution is composed of a blend of vegetable and fruit juices. Any water dispersable natural or artificial colors can be used.

The Rovimix or Vitamin C (L-Ascorbyl-2-Polyphosphate) of the spray solution is preferably an esterified form of Vitamin C, but any free form of ascorbic acid (Vitamin C) can be used. Other vitamins and/or minerals can be used in the spray if they are water soluble or dispersable and have a particle size of 150 microns or smaller.

Betaine in the inventive spray solution acts as an attractant; a combination of any of the 20 known amino acids can also be used as attractants.

Carotenoids (the Marigold extract) in the spray solution of the invention are utilized by the fish to promote and develop color in their fins and scales. Examples of carotenoids are beta carotene, canthaxanthin, astaxanthin and lutein. Any of these carotenoids can be used in the inventive spray solution. The main carotenoid present in marigold extract is beta carotene.

Significantly, all of the spray solution ingredients are water soluble.

The temperature of the flake sheet when the inventive spray solution is applied is less than 300° Fahrenheit, preferably between 250°-300° Fahrenheit. The flake sheet will be exposed to this temperature for between 1-4 seconds, preferably about 3 seconds, which minimizes vitamin C degradation. The spray solution itself is at room temperature when it is sprayed onto the flakes. The solution is not heated. The temperature of the flake sheet when the spray solution first is applied is sufficient to flash off excess moisture that is being sprayed on by the liquid spray solution (which is about 70-80% water) and will prevent or significantly reduce any degradative effects to any heat unstable nutrients (mainly vitamins, carotenoids and natural colorants). By the time the flake sheet reaches the rotating screw, it has cooled down in temperature.

To first make the slurry, the dry ingredients (at least fish meal and wheat flour) are pulverized to a particle size of no greater than 150 microns in order to make a dry type mash. The slurry is made up of the pulverized dry mash (pulverized through 100 mesh or smaller in order to obtain a consistent and smooth flake) plus water, a small amount of oil, preferably fish oil, although vegetable oil, such as soybean oil can be used, and perhaps other minor ingredients.

Chart B below identifies the various ingredients that may be included in the flake slurry of the inventive system, the weight percent amount of each if included in the slurry composition, as well as the preferred weight percent ranges for each. The most significant ingredients, as discussed, are the fish meal, flour and fish oil, as well as water.

CHART B
Flake Slurry Composition

| | Weight Percent of | % Weight |
|---|---|---|
| Ingredients | Preferred Formulation | Range |
| Water | 75 | 70-80 |
| Fish Meal | 9.85 | 7-10 |
| Wheat Flour | 5.21 | 5-7 |
| Shrimp Meal | 2.6 | 1-3 |
| Corn Gluten Meal | 2.6 | 1-3 |
| Fish Oil | 1.25 | 1-2 |
| Soy Protein | 1.02 | 0.5-2 |
| Concentrate | | |
| Krill Hydrolisate | 0.93 | 0-2 |
| Algae Meal Gold | 0.58 | 0-2 |
| Brewers Yeast | 0.58 | 0-2 |
| Dried | | |
| Lecithin (liquid) | 0.20 | 0.1-0.3 |
| Choline Chloride | 0.06 | 0.05-0.07 |
| Vitamin Premix | 0.05 | 0.04-0.06 |
| Xanthan Gum | 0.05 | 0.04-0.06 |
| DL-Methionine | 0.05 | 0.04-0.06 |
| Ethoxyquin (66%) | 0.002 | 0.001-0.003 |
| | 100 | |

Water, fish meal, wheat flour and fish oil are the four most important ingredients, as previously discussed. It is important to have more or equal amounts of fish meal as compared to wheat flour. One can use more fish meal than wheat flour, but not the other way around. One does not want to use more than twice the amount of fish meal than wheat flour. The weight range of fish meal to wheat flour is in a ratio of between 1:1 to 2:1. It is also somewhat important to make sure that there is enough fish oil so that the flakes will not overly dry and will not stick to the drum during preparation.

The flake end product typically includes about 100 lbs of spray solution to 500 lbs of flake product (1:5 ratio) although a ratio range of 0.5-1:4.5-5 is suitable. In the process, flake production is around (0.6-1 lbs/min). Thus, spray flow rate is roughly 0.15-0.17 lbs spray solution applied per minute.

Of significance is the fact that the spray solution is applied to the flake product while in the form of a sheet as it is coming off the drum dryer. The elevated temperature of the flake sheet (due to the steam in the drum dryer) at this stage (no greater than 300° F.) is critical in that it is high enough to remove excess moisture applied by the spray solution, but will not cause any significant damage to the vitamin C and carotenoids in the spray solution, which are quite heat unstable.

The necessary ingredients of the slurry/flake composition are fish meal, wheat flour and fish oil. The fish oil is an important ingredient in the slurry in order to prevent the flake from sticking to the drum dryer and is also an important attractant and a good source of omega-3 and omega-6 fatty acids. The weight percent ranges for each as well as weight percent ranges for the optional ingredients in the slurry/flake composition can be found in chart B.

What is required and what is optional in the spray solution is significant. Colorant is important in that a speckled flake product is what is desired. Vitamin C also is significant since it has previously been difficult to incorporate vitamin C into the flakes without some type of degradation. The spray solution may also be applicable for adding other types of vitamins or additives. The spray solution, in its broader sense, with appropriate weight range limitations for each of its optional and required ingredients, is found at chart A.

The following is significant in terms of the inventive system:
1. When the liquid spray solution first strikes the flake along the drum, the flake sheet has a temperature of between 250°-270° F.
2. When the sprayed flake comes off the drum, the flake temperature is between 210°-250° F.
3. When the flake is being broken up in the rotating screw, its temperature is between 110°-150° F.
4. When the broken up flake first hits the conveyer (it then travels along the conveyer to be then passed through a screen), the flake temperature is between 80°-100° F.

The following is also significant:

The time between when the liquid spray solution first strikes the flake slurry and when the sprayed flake slurry first comes off the drum is about 14 seconds.

Application of the inventive method creates a unique colored spray pattern on the fish flakes.

The inventive fish flakes have attractants sprayed onto the surface which allow fish to sense the food and will eat it very quickly. The quicker the fish eats the food, the less time the flake will be in contact with the water for Vitamin C to leach out, the more Vitamin C will still be on the flake, the more Vitamin C the fish will ingest. This is important because the fish will be attracted to the food quickly and will eat it before a significant amount of Vitamin C has leached into the water, thereby getting the required amount in order to maintain a healthy immune system. Moreover, while attractants are typically added to fish foods, they are added internally. This invention is different because they are being applied externally.

Significantly, the liquid spray solution containing vitamin C and other ingredients is applied to the fish flakes while the flakes are in the form of a sheet along a drum.

The inventive method enables the application of the appropriate amount of liquid spray solution, which prevents flake breakage, achieves a colored speckled pattern on the produced flake and facilitates the incorporation of vitamins and other ingredients into the fish flakes.

Because the liquid spray solution is applied to the sheet of flake as it is coming off the heated drum, the temperature of the sheet of flakes will effectively flash off (evaporate) the excess moisture that is being applied by the spray solution, and will not cause any significant damage to the heat-unstable vitamin C and carotenoids.

In the inventive method, the goal is to achieve a speckled color pattern on the produced fish flakes so that one can visibly see the specks and also see base flake, which is typically tan or blonde in color, between the specks. This provides a visual enhancement to the prospective customer; if he or she can see the specks, then he or she would likely be convinced that the vitamin C, carotenoids and attractants have been sprayed on to the flakes.

Because the fish flakes produced by the inventive method are somewhat thin and fragile, air pressure of the spray nozzles needs to be controlled in order to prevent the fish flakes from falling apart.

Thus, by using the inventive method, the amount of liquid spray solution and the pressure at which the liquid spray solution is being applied can be controlled in order to prevent flake breakage. The following parameters are preferred: All of these parameters in combination are significant to make the system work.
pump pressure 90-120 psi The pump is used to push the liquid through the system.
fluid pressure regulator—1.5-5 psi This controls the pressure at which the fluid is circulated through the system.
back pressure regulator—0 psi This controls the return circulated product. It must be lower than the fluid pressure regulator in order for the fluid to recirculate.
fluid pressure—45-75 psi
air pressure to the spray nozzles—70-90 psi This refers to the amount of air supplied to the spray guns.
atomizing pressure 6-40 psi This refers to the amount of air pressure pushing the liquid through the spray nozzles. This number is important because it controls the size of the liquid particles which has an effect on the speckled pattern.

With the current invention, the amount of vitamin C sprayed onto the fish flake sheet (along the drum) is controlled by knowing the usage rate and percentage of vitamin C that is added to the spray solution. The fish food product that is produced delivers more vitamin C than standard flake products, which typically have a vitamin C content in the range of between 90-200 mg/kg. The inventive fish food product has a minimum of 500 ppm of vitamin C (500 mg/kg of diet).

The following examples are applicable to the inventive system and method.

### EXAMPLE 1A

Goldfish Fines Formula

| MATERIAL DESCRIPTION | | WEIGHT % | REQUIRED POUNDS |
|---|---|---|---|
| 1 | Fish Meal | 32.45 | 650 |
| 2 | Wheat Flour | 27.45 | 550 |
| 3 | Soy Protein Concentrate | 13.18 | 264 |
| 4 | Corn Gluten Meal | 12.48 | 250 |
| 5 | Shrimp Meal | 4.99 | 100 |
| 6 | Krill Hydrolisate | 3.99 | 80 |
| 7 | Algae Meal Gold | 2.50 | 50 |
| 8 | Brewers Dried Yeast | 2.50 | 50 |
| 9 | Choline Chloride | 0.25 | 5 |
| 10 | DL-Methionine | 0.20 | 4 |
| 11 | Ethoxyquin (66%) | 0.01 | 0.3 |
| | TOTAL | 100 | 2003.3 |

### Directions:

1) Add 400 pounds of the Fish Meal.
2) Add ingredients #2-#11 and mix in a pulverizer for 20 minutes.
3) Add the rest of the Fish Meal (250 lbs).
4) Pulverize with a pulverizer, a machine that grinds down the particle size of the ingredients, all materials to 100 mesh or smaller in order to produce the Gold Fish Fines.

### EXAMPLE 1B

Goldfish Tan Flake Formula

| MATERIAL DESCRIPTION | | WEIGHT % | REQUIRED POUNDS |
|---|---|---|---|
| 1 | Goldfish Fines | 93.8 | 470 |
| 2 | Fish Oil | 5 | 25 |
| 3 | Lecithin (liquid) | 0.8 | 4 |
| 4 | Vitamin Premix | 0.2 | 1 |
| 5 | Xanthan Gum | 0.2 | 1 |
| | TOTAL | 100.00 | 501 |

### Directions:

1) Add ½ of the Fines of Example 1A to between 60-70 gallons of water and mix with a homogenizer for 10 minutes.
2) Add Fish Oil, Lecithin & Xanthan Gum and mix for 20 minutes.
3) Add the rest of the Fines slowly to the mixture and mix with a homogenizer for 10 minutes.
4) Add the Vitamin Premix to the mixture 5 minutes prior to start up of the flake.

### EXAMPLE 1C

Goldfish Red Spray Solution Formula

| MATERIAL DESCRIPTION | | WEIGHT % | REQUIRED POUNDS |
|---|---|---|---|
| 1 | Tap Water | 73.8 | 73.8 (8.7 gallons) |
| 2 | Natural Red Color | 20 | 20 |
| 3 | Rovimix (pulverized) | 5 | 5 |
| 4 | Marigold Extract (liquid) | 1 | 1 |
| 5 | Betaine | 0.2 | 0.2 |
| | TOTAL | 100.00 | 100 |

### Directions:

1) Weigh out 8.7 gallons of water in mix tank.
2) Set the mix tank speed as desired.
3) Slowly add in Rovimix, Betaine and Marigold Extract to the mix tank and close the lid. Mix for 10 minutes. Check to see that there are no lumps.
4) Add in Natural Red Color and mix for 20 minutes.
5) Turn the mix tank speed down to 4.
6) Continue agitation throughout the entire process.
7) When the solution is under the baffle in the mix tank, turn the mix tank speed down to 3.
8) When the solution is under the mixer blade of the mix tank, turn the mix tank off.

### EXAMPLE 1D

Goldfish Flakes (Sprayed)

| MATERIAL DESCRIPTION | | WEIGHT % | REQUIRED POUNDS |
|---|---|---|---|
| 1 | Goldfish Tan Flakes from | 83.3 | 500 |
| | Example 1B | | |
| 2 | Goldfish Red Spray Solution | 16.7 | 100 |
| | from Example 1C | | |
| | TOTAL | 100.00 | 600 |

### Directions:

1) Start the spray nozzles of the inventive system, making sure the settings are as indicated below.
2) Continuously spray the spray solution onto the flakes in a speckled pattern.

### Settings:

Pump Pressure: 105 psi
Fluid Pressure Regulator: 5 psi
Back Pressure Regulator: 0 psi
Air Pressure to the spray nozzles: 90 psi
Atomizing Pressure: 28 psi

### FORMULA 2A

Product: Tropical Fines

| MATERIAL DESCRIPTION | | WEIGHT % | REQUIRED POUNDS |
|---|---|---|---|
| 1 | Fish Meal | 41.93 | 850 |
| 2 | Wheat Flour | 22.20 | 450 |
| 3 | Shrimp Meal | 11.10 | 225 |
| 4 | Corn Gluten Meal | 11.10 | 225 |
| 5 | Soy Protein Concentrate | 4.34 | 88 |
| 6 | Krill Hydrolisate | 3.95 | 80 |
| 7 | Algae Meal Gold | 2.47 | 50 |
| 8 | Brewers Dried Yeast | 2.47 | 50 |
| 9 | Choline Chloride | 0.25 | 5 |
| 10 | DL-Methionine | 0.20 | 4 |
| 11 | Ethoxyquin (66%) | 0.01 | 0.3 |
| | TOTAL | 100.00 | 2027.3 |

### Directions:

1) Add 400 pounds of the Fish Meal.
2) Add ingredients #2-#9 and mix in a pulverizer for 20 minutes.
3) Add the rest of the Fish Meal (450 lbs).
4) Pulverize with a pulverizer all materials to 100 mesh or smaller in order to produce the Tropical Fines.

### EXAMPLE 2B

TROPICAL TAN Flake Formula

| MATERIAL DESCRIPTION | | WEIGHT % | REQUIRED POUNDS |
|---|---|---|---|
| 1 | Tropical Fines | 93.8 | 470 |
| 2 | Fish Oil | 5 | 25 |
| 3 | Lecithin (liquid) | 0.8 | 4 |
| 4 | Vitamin Premix | 0.2 | 1 |
| 5 | Xanthan Gum | 0.2 | 1 |
| | TOTAL | 100.00 | 501 |

### Directions:

1) Add ½ of the Fines of Example 2A to 60-70 gallons of water and mix with a homogenizer for 10 minutes.
2) Add Fish Oil, Lecithin & Xanthan Gum and mix with a homogenizer for 20 minutes.
3) Add the rest of the Fines slowly and mix with a homogenizer for 10 minutes.
4) Add the Vitamin Premix to the mixture 5 minutes prior to start up of the flake.

### EXAMPLE 2C

Tropical Blue Spray Solution Formula

| MATERIAL DESCRIPTION | | WEIGHT % | REQUIRED POUNDS |
|---|---|---|---|
| 1 | Tap Water | 73.8 | 73.8 (8.7 gallons) |
| 2 | Natural Blue Liquid Color | 20 | 20 |
| 3 | Rovimix (pulverized) | 5 | 5 |
| 4 | Marigold Extract (liquid) | 1 | 1 |
| 5 | Betaine | 0.2 | 0.2 |
| | TOTAL | 100.00 | 100 |

### Directions:

1) Weigh out 8.7 gallons of water in a mix tank.
2) Set the mix tank speed as desired.
3) Slowly add in Rovimix, Betaine and Marigold Extract to the mix tank and close the lid. Mix for 10 minutes. Check to see that there are no lumps.
4) Add in Natural Blue Color and mix for 20 minutes.
5) Turn the mix tank speed down to 4 as desired.
6) Continue agitation throughout entire process.
7) When the solution is under the baffle in the mix tank, turn the mix tank speed down to 3.
8) When the solution is under the mixer blade of the mix tank, turn the mix tank off.

### EXAMPLE 2D

Product Total Tropical Flake Sprayed

| MATERIAL DESCRIPTION | | WEIGHT % | REQUIRED POUNDS |
|---|---|---|---|
| 1 | Tropical Tan Flake From | 83.3 | 500 |
| | Example 2B | | |
| 2 | Tropical Blue Spray Solution | 16.7 | 100 |
| | from Example 2C | | |
| | TOTAL | 100.00 | 600 |

### Directions:

1) Start the spray nozzles of the inventive system, making sure the settings are as identified below.
2) Continuously spray the spray solution onto the flakes in a speckled pattern.

### Settings:

(1) Pump Pressure: 105 psi
(2) Fluid Pressure Regulator: 4 psi
(3) Back Pressure Regulator: 0 psi
(4) Air Pressure to the spray nozzles: 70 psi
(5) Atomizing Pressure: 32-34 psi

It will thus be seen that the objects set forth above, and those made apparent from the preceding description, are efficiently attained, and since certain changes may be made in the method, system and product set forth above without departing from the spirit and scope of the invention, it is intended that all matter contained in the above description and shown in the accompanying drawing shall be interpreted as illustrative and not in a limiting sense.

It is also to be understood that the following claims are intended to cover all the generic and specific features of the invention herein described, and all statements of the scope of the invention, which, as a matter of language, might be said to fall therebetween.

1-30. (canceled)

31. A system of preparing fish food flakes comprising:
a slurry which includes fish meal and flour; and
a solution including one or more water soluble or dispersible nutritional ingredients suitable for spraying onto the slurry during heat drying such that degradation of said nutritional ingredients is prevented.

32. The system of claim 31, wherein the slurry has a solid portion which includes said fish meal and said flour in an amount between about 70 and 80 weight percent and a liquid portion comprising about 20 and 30 weight percent.

33. The system of claim 31, wherein said slurry further includes an oil.

34. The system of claim 33, wherein said fish meal is present in an amount between about 7-10 weight percent, the flour is present in an amount between about 5 and 7 weight percent and the oil is present in an amount between about 1-2 weight percent.

35. The system of claim 31, wherein the slurry is at a temperature of less than about 300° F. when said solution is sprayed thereon.

36. The system of claim 31, wherein said nutritional ingredients have a particle size of no greater than 150 microns.

37. The system of claim 31, wherein said one or more nutritional ingredients comprise at least one of vitamin C and a carotenoid.

38. The system of claim 37, wherein said vitamin C is esterified.

39. The system of claim 37, wherein said carotenoid is selected from the group consisting of beta-carotene, astaxanthin and lutein.

40. The system of claim 37, wherein said nutritional ingredients further include at least one of an attractant and a palatant.

41. The system of claim 40, wherein the attractant is an amino acid.

42. The system of claim 31, wherein said fish meal and said flour are pulverized to a particle size of no greater than about 100 mesh.

43. The system of claim 31, wherein said spray solution further includes a colorant.

44. The system of claim 43, wherein the colorant is a natural colorant.

45. The system of claim 44, wherein the natural colorant is selected from the group consisting of carmine and fruit and vegetable extracts.

46. The system of claim 31, wherein the weight ratio of fish meal to flour is between about 1:1 and 2:1.

47. The system of claim 31, wherein said nutritional ingredients are selected from the group comprising vitamins and minerals.

48-63. (canceled)
